(19) United States
(12) Patent Application Publication
(10) Pub. No.: US 2025/0013211 A1
(43) Pub. Date: Jan. 9, 2025

(54) AUTOMATIC PARAMETER ADJUSTMENT DEVICE, AUTOMATIC PARAMETER ADJUSTMENT SYSTEM, AND AUTOMATIC PARAMETER ADJUSTMENT METHOD

(71) Applicant: Panasonic Intellectual Property Management Co., Ltd., Osaka (JP)

(72) Inventors: Naganori SHIRAKATA, Osaka (JP); Shun TAKAYANAGI, Osaka (JP); Taichi SATO, Kyoto (JP); Takayuki TSUKIZAWA, Osaka (JP); Takeshi ARAI, Osaka (JP)

(21) Appl. No.: 18/709,355

(22) PCT Filed: Jun. 29, 2022
(86) PCT No.: PCT/JP2022/025873

§ 371 Date: May 10, 2024

(30) Foreign Application Priority Data
Nov. 12, 2021 (JP) 2021-184816

(51) Int. Cl. G05B 13/04

(52) U.S. Cl. CPC G05B 13/042

(57) ABSTRACT

The present disclosure relates to a technology for automatically and efficiently searching for a facility control parameter. One aspect of the present disclosure relates to an automatic parameter adjustment device comprising: a plurality of facility models that model a facility; a control parameter setter that sets a plurality of first control parameters for use in a first trial to the plurality of facility models, and set a second control parameter for use in the first trial to the facility; and a comparer that compares a model operation result of the first trial of the plurality of facility models under the plurality of first control parameters with an actual machine operation result of the first trial of the facility under the second control parameter, wherein the control parameter setter selects a control parameter for use in a second trial based on a first comparison result between the model operation result of the first trial and the actual machine operation result of the first trial.

### TECHNICAL FIELD

The present disclosure relates to an automatic parameter adjustment device, an automatic parameter adjustment system and an automatic parameter adjustment method.

### BACKGROUND ART

In production facilities used in factories and the like, such as component mounting machines and assembly robots, a plurality of servo control motors are combined to perform complex and elaborate operation controls. In such devices, to-be-controlled operations are controlled in accordance with multiple control parameters. To achieve the desired performance, the user empirically adjusts the control parameters.

The more diverse and complex the operation conditions are, and the greater the number of parameters are, the more difficult it is to perform the adjustment steps for the control parameters, requiring a great deal of effort and time. Under such circumstances, there is an increasing demand for automation of the adjustment steps.

In view of this, there is a technique of modeling a to-be-controlled production facility, and extracting candidates for the parameters to be adjusted through a simulation.

### CITATION LIST

### Patent Literature

### PTL 1

Japanese Patent Application Laid-Open No. 2017-102619

### SUMMARY OF INVENTION

### Technical Problem

However, if several tens to hundreds control parameters are used, the number of combinations are enormous, and it is very time consuming to sequentially operate parameter optimization through simulations and optimizations with actual machines.

In addition, if the operation range of the actual machine is limited to a narrower range than the candidates of the control parameters extracted through a simulation, it may not become robust to disturbances caused by the environment in which the machine is installed, and may have difficulty converging to the optimal value. For example, it may become difficult to achieve appropriate control parameter search due to the modeling error of a facility model and the evaluation error of the actual machine.

The present disclosure relates to a technique for efficiently performing automatic search of the control parameter for a facility.

### Solution to Problem

One aspect of the present disclosure relates to an automatic parameter adjustment device comprising: a plurality of facility models that model a facility: a control parameter setter that sets a plurality of first control parameters for use in a first trial to the plurality of facility models, and set a second control parameter for use in the first trial to the facility; and a comparer that compares a model operation result of the first trial of the plurality of facility models under the plurality of first control parameters with an actual machine operation result of the first trial of the facility under the second control parameter, wherein the control parameter setter selects a control parameter for use in a second trial based on a first comparison result between the model operation result of the first trial and the actual machine operation result of the first trial.

Another aspect of the present disclosure relates to a computer-implemented automatic parameter adjustment method, the method comprising: setting a plurality of first control parameters for use in a first trial to a plurality of facility models modeling a facility, and setting a second control parameter for use in the first trial to the facility: comparing a model operation result of the first trial of the plurality of facility models under the plurality of first control parameters with an actual machine operation result of the first trial of the facility under the second control parameter; and selecting a control parameter for use in a second trial based on a first comparison result between the model operation result of the first trial and the actual machine operation result of the first trial.

These comprehensive or specific aspects may be realized in a system, method, integrated circuit, computer program or recording medium, or in any combination of a system, device, method, integrated circuit, computer program and recording medium.

### Advantageous Effects of Invention

According to the above-mentioned aspects of the present disclosure, it is possible to provide a technique for efficiently and automatically searching control parameters for a facility.

Further advantages and effects of aspects of the present disclosure are revealed in the specification and drawings. Such advantages and/or effects are provided by some embodiments and features described in the specification and drawings, but not necessarily all in order to obtain one or more identical features.

### BRIEF DESCRIPTION OF DRAWINGS

FIG. 1 is a diagram illustrating an example of a configuration of an automatic parameter adjustment system according to an embodiment of the present disclosure illustrating;

FIG. 2 is a diagram illustrating a functional configuration of an automatic parameter adjustment device according to the embodiment of the present disclosure:

FIG. 3 is a diagram illustrating a hardware configuration of the automatic parameter adjustment device according to the embodiment of the present disclosure: FIG. 4 is a diagram illustrating an example of a data configuration of an operation condition parameter according to the embodiment of the present disclosure:

FIG. 5 is a diagram illustrating an example of a data configuration of a control condition parameter according to the embodiment of the present disclosure:

FIG. 6 is a diagram illustrating an example of an operation sequence of the automatic parameter adjustment system according to the embodiment of the present disclosure:

FIG. 7 is a flowchart illustrating an example of an automatic parameter adjustment process according to the embodiment of the present disclosure:

FIG. 8 is a diagram illustrating an example of a parameter adjustment result display according to the embodiment of the present disclosure:

FIG. 9 is a diagram illustrating an example of the parameter adjustment result display according to the embodiment of the present disclosure; and

FIG. 10 is a diagram illustrating an example of the parameter adjustment result display according to the embodiment of the present disclosure.

### DESCRIPTION OF EMBODIMENTS

An embodiment of the present disclosure is elaborated below with reference to the accompanying drawings. Note that the embodiment described below is an example, and the present disclosure is not limited to the following embodiment.

An embodiment of the present disclosure is elaborated below with reference to the drawings. It should be noted that more detailed explanations than necessary may be omitted. For example, detailed explanations of well-known matters, duplicate explanations of substantially identical configurations, etc. may be omitted. This is to avoid unnecessary redundancy in the following description and to facilitate the understanding of those skilled in the art.

The accompanying drawings and the following description are provided to enable those skilled in the art to fully understand the disclosure, and are not intended to limit the subject matter recited in the claims.

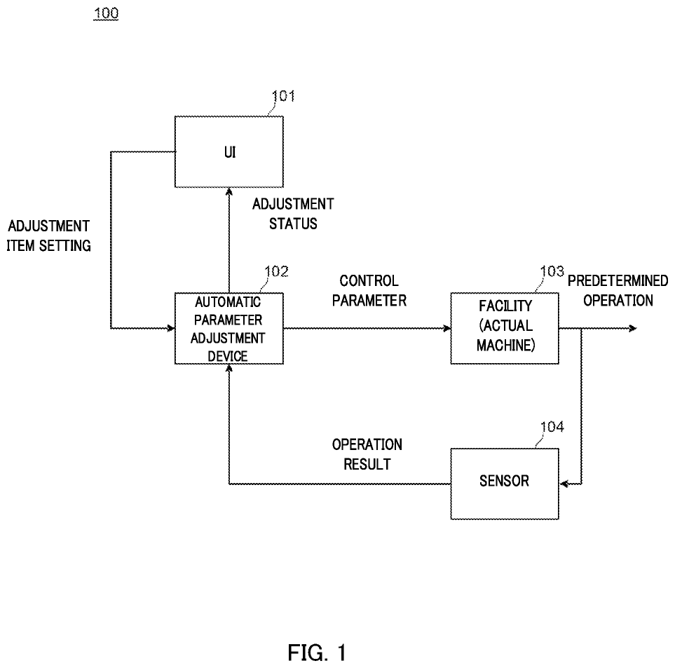

First, with reference to FIG. 1, an automatic parameter adjustment system according to the embodiment of the present disclosure is described. FIG. 1 is a diagram illustrating an example of the automatic parameter adjustment system according to the embodiment of the present disclosure.

As illustrated in FIG. 1, an automatic parameter adjustment system 100 includes a user interface (UI) 101, an automatic parameter adjustment device 102, a facility 103 and a sensor 104. The automatic parameter adjustment system 100 adjusts the control parameter such that a predetermined operation of the facility 103 such as a component mounting machine satisfies a predetermined performance (e.g., positional accuracy, setting time, vibration, sound, noise, power consumption and the like).

The UI 101, which is implemented by, for example, an UI device such as a display, a keyboard and a mouse, receives adjustment items (e.g., the operation condition, desired performance, priority parameter and the like) from a user and passes the received adjustment item to the automatic parameter adjustment device 102.

As described in detail below, the automatic parameter adjustment device 102 determines the search range of the control parameter for the facility 103 on the basis of the adjustment item received from the user, and outputs a candidate control parameter.

The facility 103 is a mounting machine such as a production facility, and executes a predetermined operation on the basis of the control parameter set by the automatic parameter adjustment device 102.

The sensor 104 detects an operation result (e.g., a performance value related to the operation and the like) of the facility 103 that operates in accordance with the configured control parameter, and passes the operation result to the automatic parameter adjustment device 102.

Then, the automatic parameter adjustment device 102 evaluates the configured control parameter on the basis of the performance value acquired from the sensor, and determines the next control parameter set for the facility 103 on the basis of the evaluation result. In this manner, the automatic parameter adjustment device 102 repeats the above-described control parameter adjustment process to optimize the control parameter (this sequence of operations is referred to as a trial). In addition, the automatic parameter adjustment device 102 displays the adjustment status of the control parameter to the user through the UI 101.

In this manner, the automatic parameter adjustment system 100 presents the control parameter for which a predetermined performance is obtained to the user as the adjustment result, and sets it to the facility 103.

Note that the blocks illustrated in the drawing may be mounted in one device, or in respective different devices. For example, the facility 103 may be mounted as one device including the UI 101, the automatic parameter adjustment device 102 and the sensor 104. Alternatively, it is possible to adopt a configuration in which the automatic parameter adjustment device 102 is implemented on a cloud, the UI 101 is mounted in a local PC (Personal Computer), a smartphone, a tablet or the like of the user, and each block is connected through a communication network (not illustrated). In addition, a plurality of pieces of the facility 103 and/or a plurality of sensors 104 may be installed. Furthermore, the UI 101 and/or the automatic parameter adjustment device 102 may not only set the adjustment item input from the user, but also perform setting of control parameters and acquisition of operation results by operating a GUI (Graphical User Interface) of existing adjusting software for manually performing the parameter adjustment of the conventional facility 103 by using an RPA (Robotic Process Automation) that automatically controls it through image recognition and the like. In this manner, the automatic parameter adjustment can be performed even for the conventional facility 103 provided with no dedicated communication interface.

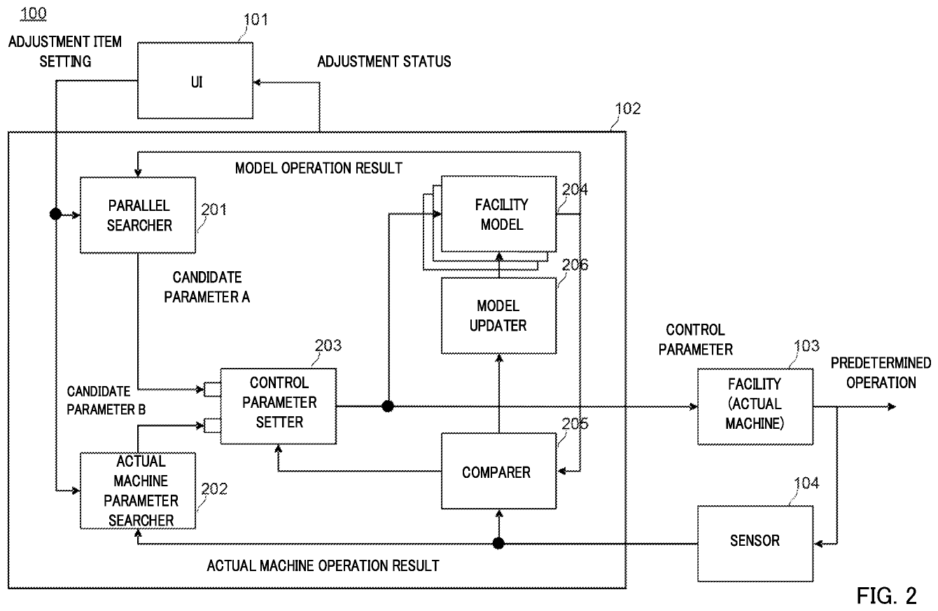

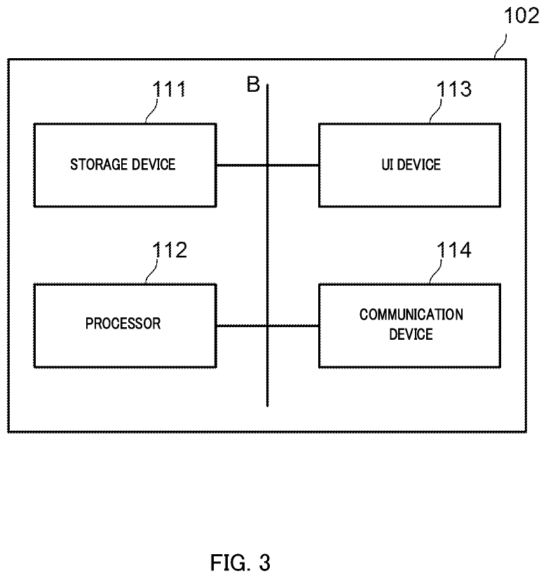

Next, with reference to FIGS. 2 and 3, the automatic parameter adjustment device 102 according to the embodiment of the present disclosure is described. FIG. 2 is a diagram illustrating an example of a functional configuration of the automatic parameter adjustment device 102 according to the embodiment of the present disclosure.

As illustrated in FIG. 2, the automatic parameter adjustment device 102 includes a parallel searcher 201, an actual machine parameter searcher 202, a control parameter setter 203, a facility model 204, a comparer 205 and a model updater 206.

The parallel searcher 201 executes an operation simulation of the facility 103 by using a plurality of the facility models 204 of the facility 103 to search for a control parameter. More specifically, the parallel searcher 201 searches for a combination of control parameters with which the desired performance is achieved on the basis of a limitation of an adjustment item configured through the UI 101, and outputs the candidate control parameter to the control parameter setter 203. For example, the candidate control parameter may be selected on the basis of the simulation result output from the facility model 204.

The actual machine parameter searcher 202 causes the facility 103 to execute a physical operation, and searches for the control parameter on the basis of the actual machine operation result. More specifically, the actual machine parameter searcher 202 searches for a combination of control parameters with which the desired performance is achieved on the basis of a limitation of the adjustment item configured through the UI 101, and outputs the candidate control parameter to the control parameter setter 203. For example, the candidate control parameter may be selected on the basis of the actual machine operation result detected by the selection sensor 104.

The control parameter setter 203 selects a trial control parameter from among a plurality of candidate parameters acquired from the parallel searcher 201 and the actual machine parameter searcher 202, and sets the selected control parameter to the facility model 204 and the facility 103. For example, the control parameter may be selected on the basis of the output result of the comparer 205.

The plurality of facility models 204 is configured by modeling the operation of the facility 103, and can execute simulations. The same or different control parameters may be set for the facility models 204. In addition, the plurality of facility models 204 may be the same or different from each other. Various methods may be used for the modeling of the operation of the facility 103. For example, the facility model 204 may be based on mathematical models with transfer functions and/or differential equations, structural analysis models using CAD models, multiphysics, multi-body dynamics models and the like. With the facility model 204, performance indices such as operation duration, movement accuracy, and vibration can be simulated. Alternatively, the facility model 204 may be based on a machine learning model that estimates and outputs the actual machine operation result of the facility 103 for input parameters. Alternatively, the facility model 204 may be a hybrid model composed of a combination of them. Publicly known various machine learning methods may be applied. For example, the facility model 204 may be a hybrid model composed of a combination of them. Deep learning using a neural network that employs publicly known various machine learning methods to generate a time-series pattern, and the like may be used. In addition, the plurality of facility models 204 may be prepared and simulations of the facility models 204 may be simultaneously performed. In this manner, a plurality of control parameters and/or constraint conditions can be simultaneously evaluated, and thus the searching time for the control parameter can be reduced.

The comparer 205 compares the model operation result of the facility model 204 with the actual machine operation result output from the sensor 104. More specifically, the comparer 205 compares the operation result of the facility 103 with the operation result of the facility model 204 for the control parameter configured by the control parameter setter 203, and performs selection of the control parameter in the next trial and the update determination of the facility model 204. The output related to the selection of the control parameter is notified to the control parameter setter 203, and the output related to the update of the facility model is notified to the model updater 206.

The model updater 206 updates the facility model 204 on the basis of the output from the comparer 205. More specifically, the model updater 206 adjusts an internal parameter of the facility model 204 such that the operation with the same control parameter substantially match the facility 103. In this manner, the model updater 206 can reflect an operation, an individual difference or others of the facility 103 under an actual installed environment on an operation of the facility model 204 to improve the accuracy and efficiency of the control parameter search.

For example, the statuses of these internal blocks may be output to the UI 101 and notified to the user as adjustment statuses.

Note that parameter search can use publicly known various algorithms. For example, heuristic algorithms such as Bayesian optimization, genetic algorithms and particles optimization, mathematical programming, various solutions for combinatorial optimization and the like may be used.

In addition, information about a search space may be shared between the parallel searcher 201 and the actual machine parameter searcher 202. For example, search range information at the current time point, past search histories and the like may be exchanged.

Here, the automatic parameter adjustment device 102 may be implemented by a given calculation device such as a server and a personal computer, and may include the hardware configuration illustrated in FIG. 3, for example. For example, the automatic parameter adjustment device 102 includes a storage device 111, a processor 112, a user interface (UI) device 113 and a communication device 114, which are connected one another through bus B.

Programs or instructions for implementing various functions and processes described later at the automatic parameter adjustment device 102 may be downloaded from a given external device through a network, or may be provided from a removable storage medium such as a CD-ROM (Compact Disk-Read Only Memory), and a flash memory.

The storage device 111, which is implemented by a random access memory, a flash memory, a hard disk drive or the like, stores files, data and the like for use in execution of programs or instructions together with installed programs or instructions. The storage device 111 may include a non-transitory storage medium.

The processor 112 may be implemented by one or more CPUs (Central Processing Unit) that may be composed of one or more processor cores, GPUs (Graphics Processing Unit), processing circuits (processing circuitry) and the like, and executes various functions and processes of the automatic parameter adjustment device 102 described later in accordance with data of the programs, instructions, parameters used for executing the programs or instructions and the like stored in the storage device 111. The user interface (UI) device 113 may be composed of an input device such as a keyboard, a mouse, a camera and a microphone, an output device such as a display, a speaker, a head set and a printer, and an input/output device such as a touch panel, and implements the interface between a user and the automatic parameter adjustment device 102. For example, the user operates the automatic parameter adjustment device 102 by operating the GUI (Graphical User Interface) displayed on the display or the touch panel with the keyboard, the mouse or the like. The communication device 114 is implemented by various communication circuits that execute communication processes with external devices, the Internet, and communication networks such as LAN (Local Area Network).

Note that the above-described hardware configuration is merely an example, and the automatic parameter adjustment device 102 according to the present disclosure may be appropriately implemented by any other hardware configurations.

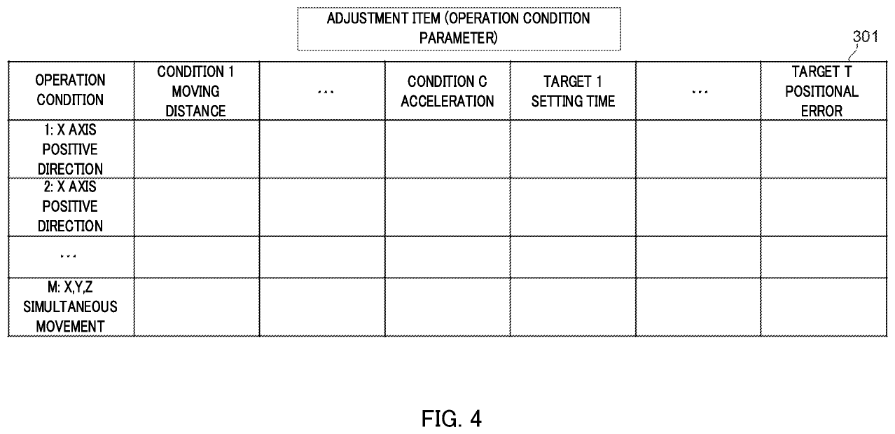

Next, with reference to FIGS. 4 and 5, an adjustment item according to the embodiment of the present disclosure is described. FIG. 4 is a diagram illustrating an example of a data configuration of an adjustment item of an operation condition parameter 301 according to the embodiment of the present disclosure, and FIG. 5 is a diagram illustrating an example of a data configuration of an adjustment item of a control condition parameter 302 according to the embodiment of the present disclosure. Note that the adjustment item illustrated in the drawing is merely an example, and appropriate adjustment items may be set in accordance with the to-be-configured facility 103.

As illustrated in FIGS. 4 and 5, the adjustment item is composed of M operation conditions, and the parameter is set for each operation condition. The operation conditions are operation patterns divided into partial operations such as operations of the arm and mounting operations of components, for example.

An operation condition parameter 301 defines a given operation of the facility 103, and is composed of C condition parameters and T target performance parameters in the illustrated example. The condition parameter may be a limit value of the movement direction, the movement length, the acceleration time, the acceleration, and the like for example. The target performance parameter may be the positioning setting time, the positional error, the amount of overshoot of the vibration and the like, for example.

A control condition parameter 302 defines the setting range of the control parameter of the facility 103, and is composed of P control parameters and T performance weight parameters in the example illustrated in the drawing. The control parameter may be, for example, a range, a setting unit (step), a set of discrete values or the like of numerical data such as the resonance frequency, time constants, and control gains of the control filter, category data such as filter configuration mode setting and the like that can be set for the facility 103. The performance weight parameter may set the degree of weighting of each item of the target performance with respect to the evaluation, for example.

These control parameters selected from the input data are set to the facility model 204 and the facility 103, and a predetermined operation is executed with the set control parameter. Further, the performance value of the resulting operation is measured.

An evaluation parameter 303 is an evaluation value for parameter search, and is a value obtained by performing weighting with the performance weight parameter on each output result of the case where control parameters are set to M operation conditions. For example, when the target performance is satisfied for all operation conditions, the weights for all parameters are equally set. On the other hand, when prioritizing the operation condition, and/or prioritizing the desired performance for each operation condition, the evaluation value may be calculated by adjusting the weight. In addition, the evaluation value may be a value obtained by converting the weighted output result by an evaluation value function. For example, the evaluation function may calculate the simple sum of weighted output results or the sum of degrees of achievement (rates) of the output results to a target performance. In this case, the searching algorithm may be set to search for the control parameter that minimizes or maximizes the evaluation value by setting the evaluation function.

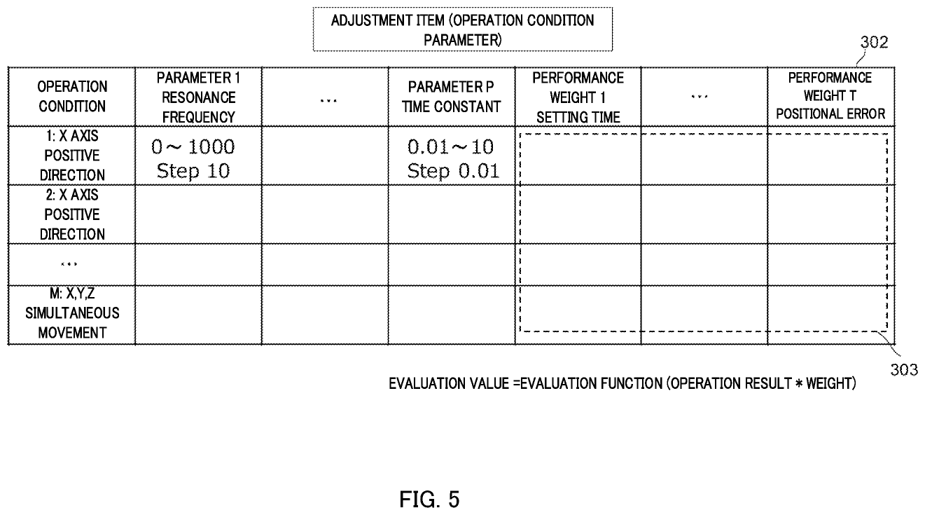

Next, an operation of the automatic parameter adjustment system 100 according to the embodiment of the present disclosure is described with reference to FIG. 6. FIG. 6 is a diagram illustrating an example of an operation sequence of the automatic parameter adjustment system 100 according to the embodiment of the present disclosure.

As illustrated in FIG. 6, at step S401, the UI 101 transmits an adjustment item set by the user to the parallel searcher 201 and the actual machine parameter searcher 202.

At step S402, the parallel searcher 201 selects a plurality of candidate parameters A for the facility model 204 from the search space that is set based on the adjustment item, and transmits the selected plurality of candidate parameters A to the control parameter setter 203. For example, as candidate parameter A, a combination of candidate parameters that differs for each of the plurality of facility models 204 may be given simultaneously (in parallel).

At step S403, the actual machine parameter searcher 202 selects a plurality of candidate parameters B for the facility 103 from the search space that is set based on the adjustment item, and transmits the selected plurality of candidate parameters B to the control parameter setter 203. For example, as candidate parameter B, a combination of different candidate parameters may be given sequentially (in series) to one facility 103.

At step S404, the control parameter setter 203 selects a trial parameter that is set to each facility model 204 from among candidate parameters A and B, and transmits the selected trial parameter to each facility model 204. For example, as the trial parameter, a combination of trial parameters that differs for each of the plurality of facility models 204 may be given simultaneously (in parallel).

At step S405, the control parameter setter 203 selects the trial parameter that is set to the facility 103 from among candidate parameters A and B, and transmits the selected trial parameter to the facility 103. For example, as the trial parameter, a combination of different trial parameters may be given sequentially (in series) to one facility 103.

At step S406, the sensor 104 acquires an actual machine operation result of the facility 103 operated with the set trial parameter. The actual machine operation result represents an operation of the facility 103 (e.g., a movement of the arm), and may represent a physical quantity of the facility 103 detected or/and measured by the sensor 104.

At step S407, each facility model 204 executes a simulation in accordance with the set trial parameter, and transmits each model operation result to the parallel searcher 201 and the comparer 205.

At step S408, the sensor 104 transmits the acquired actual machine operation result to the actual machine parameter searcher 202 and the comparer 205.

At step S409, the comparer 205 compares the model operation result with the actual machine operation result, and transmits parameter switching determination information to the control parameter setter 203 on the basis of the comparison result. For example, when the model evaluation value and the actual machine evaluation value significantly deviate from each other, the parameter switching determination information may instruct the control parameter setter to select the control parameter such that the deviation between the model evaluation value and the actual machine evaluation value is reduced.

At step S410, the comparer 205 compares the model operation result with the actual machine operation result, and transmits model update determination information to the model updater 206 on the basis of the comparison result. For example, when the model evaluation value and the actual machine evaluation value significantly deviate from each other, the model update determination information may instruct the model updater 206 to update an internal parameter of the facility model 204 such that the deviation between the model evaluation value and the actual machine evaluation value is reduced.

At step S411, the model updater 206 transmits model update information to the facility model 204 on the basis of the model update determination information.

At step S412, the control parameter setter 203 transmits control parameter information to the UI 101 on the basis of candidate parameters A and B and the parameter switching determination information. For example, the control parameter information may represent the current adjustment progress.

At step S413, the comparer 205 transmits comparison information to the UI 101 on the basis of the comparison between the model operation result and the actual machine operation result. For example, the comparison information may represent the current adjustment progress.

The above-described steps S402 to S413 are repeated until the control parameter that satisfies the target performance set by the user is acquired.

When the control parameter that satisfies the target performance is acquired, at step S414, the control parameter setter 203 transmits the adjustment result to the UI 101, and the automatic parameter adjustment process is terminated.

Note that when the simulation with the facility model 204 can be executed sufficiently faster than the actual machine operation, parallel search of the facility model 204 (S402, S403, S404, S407) may be executed multiple times during the operation of the actual machine (S406 to S408). In addition, a plurality of actual machine operation results may be output by inputting a plurality of trial parameters to the facility 103 at step S405, and sequentially executing them at the facility 103.

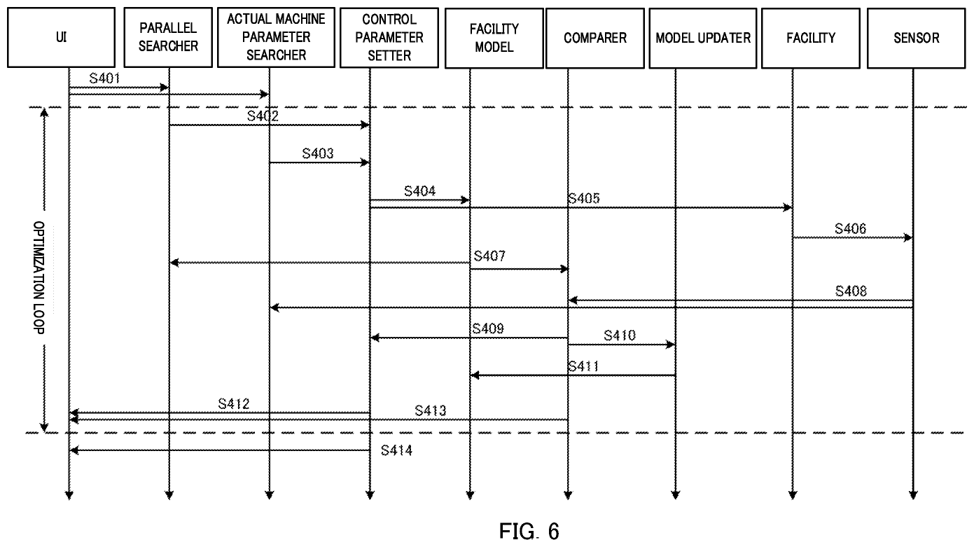

Next, with reference to FIG. 7, an operation of the automatic parameter adjustment device 102 according to the embodiment of the present disclosure is described. FIG. 7 is a flowchart illustrating an operation of the automatic parameter adjustment device 102 according to the embodiment of the present disclosure.

As illustrated in FIG. 7, at step S501, the automatic parameter adjustment device 102 receives adjustment items such as the operation condition, target performance, control parameter range, and performance evaluation weight from the UI 101.

At step S502, the automatic parameter adjustment device 102 selects the candidate parameter from the parameter search space in accordance with the set adjustment item at the parallel searcher 201 and the actual machine parameter searcher 202.

At step S503, the automatic parameter adjustment device 102 selects a trial parameter from among a plurality of candidate parameters.

At step S504, the automatic parameter adjustment device 102 sets the selected trial parameter to the facility model 204 and the facility 103. The actual machine operation and the simulation in a predetermined operation are executed in accordance with the set trial parameter.

At step S505, the automatic parameter adjustment device 102 acquires evaluation values of the operation result of the simulation of the facility model 204 and the actual machine operation result of the facility 103.

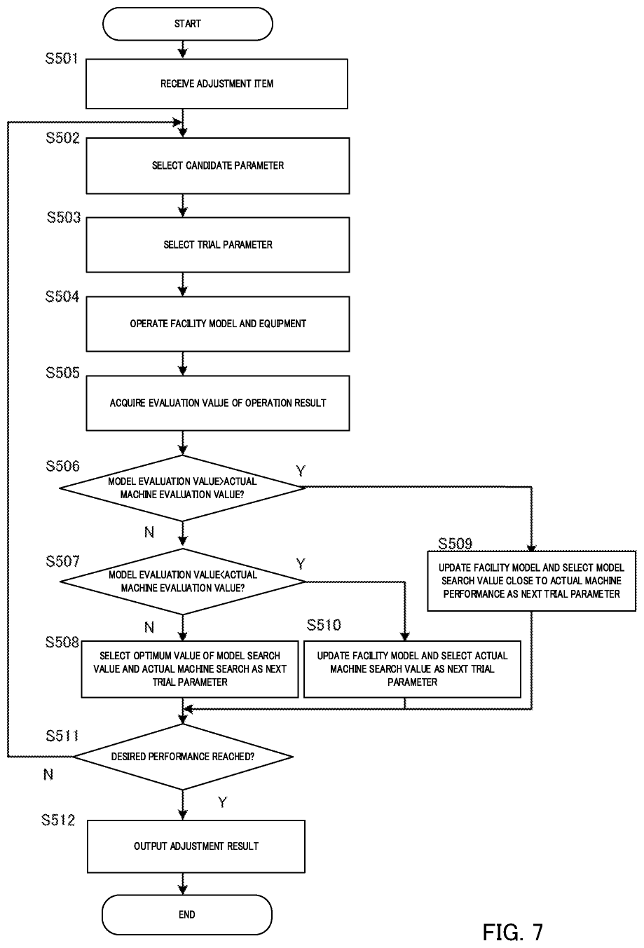

At step S506, the automatic parameter adjustment device 102 compares the model evaluation value of the facility model 204 with the actual machine evaluation value of the facility 103. When a plurality of model evaluation values is higher than the actual machine evaluation value by a predetermined difference or more (S506: Y), the automatic parameter adjustment device 102 advances the process to step S509; otherwise (S506: N), it advances the process to step S507 as illustrated in FIG. 8.

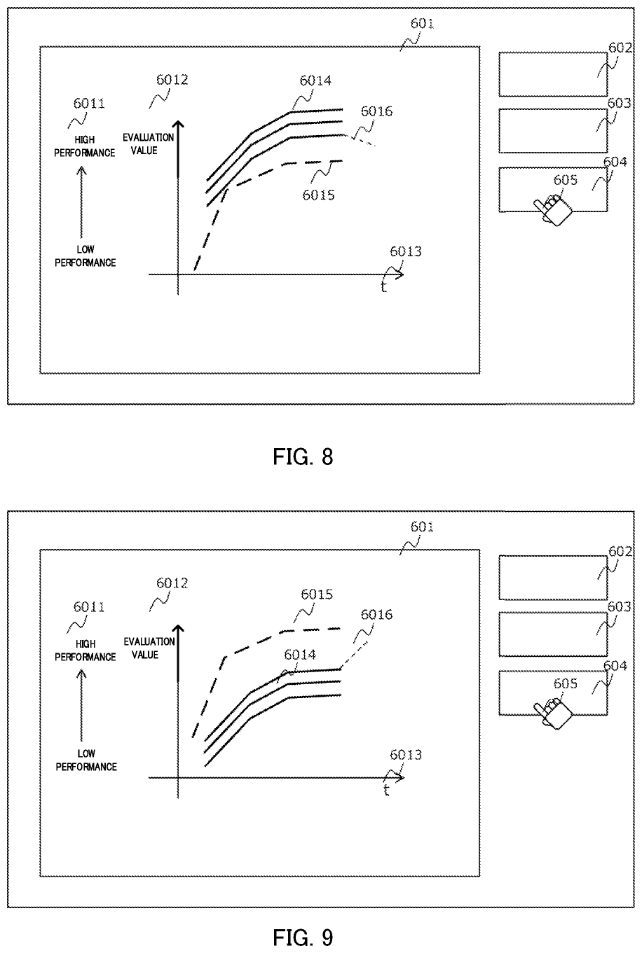

At step S507, the automatic parameter adjustment device 102 compares the model evaluation value of the facility model 204 with the actual machine evaluation value of the facility 103. When a plurality of model evaluation values is lower than the actual machine evaluation value by a predetermined difference or more (S507: Y), the automatic parameter adjustment device 102 advances the process to step S510; otherwise (S507: N), it advances the process to step S508 as illustrated in FIG. 9.

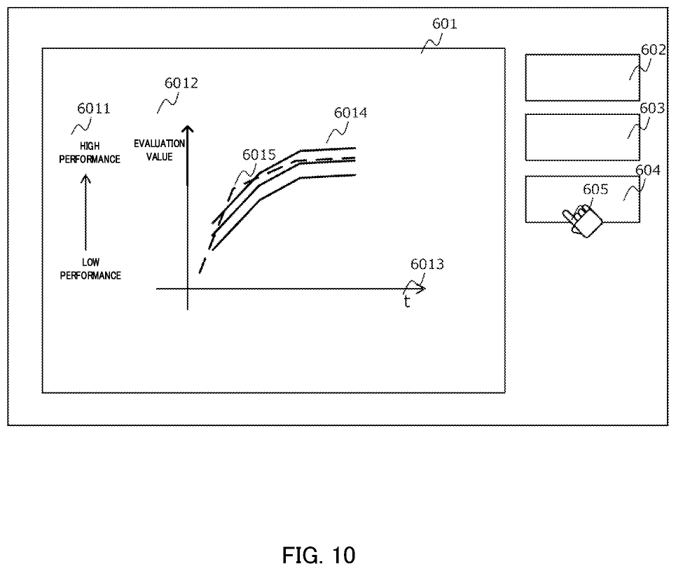

At step S508, when the model evaluation value of the facility model 204 and the actual machine evaluation value of the facility 103 are in substantially the same state as illustrated in FIG. 10, the automatic parameter adjustment device 102 selects the next trial parameter on the basis of the control parameter for which the optimum value is obtained in the model evaluation value of the facility model 204 and the actual machine evaluation value of the facility 103, and advances the process to step S511.

At step S509, the automatic parameter adjustment device 102 updates an internal parameter of the facility model 204 to reduce the evaluation value of the facility model 204 such that the model evaluation value of the facility model 204 is closer to the actual machine evaluation value of the facility 103. In addition, the automatic parameter adjustment device 102 selects the next trial parameter on the basis of the control parameter for which a result closest to the actual machine evaluation value of the facility 103 is obtained among the model evaluation values, and advances the process to step S511.

At step S510, the automatic parameter adjustment device 102 updates the internal parameter of the facility model 204 to increase the evaluation value of the facility model 204 such that the model evaluation value of the facility model 204 is closer to the actual machine evaluation value of the facility 103. In addition, the automatic parameter adjustment device 102 selects the next trial parameter on the basis of the control parameter for which the actual machine evaluation value of the facility 103 is obtained, and advances the process to step S511.

At step S511, the automatic parameter adjustment device 102 determines whether the actual machine evaluation value of the facility 103 has reached a target performance.

When it has reached the target performance (S511: Y), the automatic parameter adjustment device 102 advances the process to step S512, whereas when it has not reached the target performance (S511: N), it advances the process to step S502. Note that in FIGS. 7, S502 to S511 are the trials.

At step S512, the automatic parameter adjustment device 102 outputs and displays an adjusted final result, and terminates the adjusting operation.

Next, with reference to FIGS. 8 to 10, a user interface (UI) display according to the embodiment of the present disclosure is described. As described above, the UI 101 may include a display device that can display to the user the adjustment process of the parameter adjustment process in the automatic parameter adjustment system 10.

FIG. 8 is a diagram illustrating an example of the parameter adjustment result display according to the embodiment of the present disclosure. As illustrated in FIG. 8, the UI 101 includes an adjustment progress graph 601, an operation condition parameter setting area 602, a control condition parameter setting area 603, an evaluation progress setting area 604, and a pointer 605 of a cursor, a touch interface or the like.

The adjustment progress graph 601 illustrates progresses of evaluation values during the parameter adjustment. The adjustment progress graph 601 includes an indicator 6011 that indicates the high/low direction of the performance, a selected ordinate label 6012 (e.g., an evaluation value by an evaluation function, a specific performance value and the like), a selected abscissa label 6013 (e.g., evaluation elapsed time t, the number of times of trials and the like), a model evaluation value 6014 for a plurality of selected trial parameters, an actual machine evaluation value 6015 for a selected trial parameter, and a model update direction 6016.

When clicked or tapped by a user, an operation condition parameter 301 can be displayed or/and edited in the operation condition parameter setting area 602. As the graphical user interface (GUI), table editing, value selection with sliders and the like may be used.

When clicked or tapped by the user, a control condition parameter 302 can be displayed or/and edited in the control condition parameter setting area 603. As the GUI, table editing, a drop down menu, value selection with sliders and the like may be used. In addition, the user visibility can be increased by expressing a performance weight parameter with a heat map.

When clicked or tapped by the user, execution of commands to start, interrupt or/and terminate the automatic adjustment and the like, selection of displayed content on the adjustment progress graph 601 and the like can be performed in the evaluation progress setting area 604. As the GUI, value selection with a drop down menu, a radio button, a check box and the like may be used.

As illustrated in the drawing, when a model evaluation value 6014 is higher than an actual machine evaluation value 6015 by a predetermined difference or more, the following two situations are possible: 1. a situation where a disturbance component of the facility 103 and the like are not appropriately reflected on the facility model 204, and the performance of the model evaluation value 6014 tends to be higher than that of the actual machine evaluation value 6015 in simulations; and 2. a situation where a trial parameter that may possibly provide a performance higher than the trial parameter that is set to the facility 103 is set to the facility model 204. Thus, it is possible to display update of the facility model 103 in the direction (6016) in which an output of the facility model 204 comes closer to an output of the facility 103 by performing adjustment of the disturbance component of the facility model 204 and the like. In addition, a trial parameter that possibly provide a high performance for the facility 103 can be selected from among the trial parameters of the facility model 204, and can be used for the next trial parameter search.

Note that an indicator 6011 indicates which direction has a high performance with the selected ordinate label 6012. For example, in the case where the positional error is selected on the ordinate, the indicator 6011 is a down-arrow and the lower label is “high performance” because it can be interpreted that the smaller the positional error value, the higher the performance. Alternatively, in the case of an evaluation value obtained by weighting a plurality of performance values and applying it to an evaluation function, the indicator 6011 is an up-arrow and the upper label is “high performance” for an evaluation function that returns a larger evaluation value for the higher the performance. In this manner, the user can easily recognize the performance without misunderstanding the meaning of the graph. Further, the upper and lower sides can be switched by clicking the indicator 6011 with the upper and lower sides of the graph switched accordingly. In this manner, the evaluation values and the performance values may be displayed in accordance with the user's preference.

In addition, the line segments of the model evaluation value 6014, the actual machine evaluation value 6015 and/or the model update direction 6016 may be clicked, tapped or pointed with the pointer 605 so as to display related control parameter values and the like in the form of a pop up display or the like.

FIG. 9 is a diagram illustrating an example of a parameter adjustment result display according to the embodiment of the present disclosure. The example illustrated in FIG. 9 illustrates an exemplary state where the model evaluation value 6014 is lower than the actual machine evaluation value 6015.

When the model evaluation value 6014 is lower than the actual machine evaluation value 6015 by a predetermined difference or more, the following two situations are possible: 1. a situation where the sensitivity of the facility 103 and the like are not reflected on the facility model 204, and the model evaluation value 6014 tends to provide a performance lower than that of the actual machine evaluation value 6015 in simulations; and 2. a situation where the trial parameter that is set to the facility 103 provides a performance higher than that of the trial parameter of the facility model 204. Therefore, it is possible to display update of the facility model 204 in the direction (6016) in which an output of the facility model 204 comes closer to an output of the facility 103 by performing adjustment of the sensitivity of the facility model 204 and the like. In addition, since a trial parameter that provides a high performance for the facility 103 is set, it can be continuously used for the search of the next trial parameter.

FIG. 10 is a diagram illustrating an example of a parameter adjustment result display according to the embodiment of the present disclosure. The example illustrated in FIG. 10 illustrates an exemplary state where the model evaluation value 6014 and the actual machine evaluation value 6015 substantially match each other.

In this case, it is considered that: 1. operation results of the facility model 204 and the facility 103 substantially match each other for the same control parameter; and 2. a plurality of trial parameters that are set to the facility model 204 includes a parameter that can possibly provide a performance higher than that of the parameter that is set to the facility 103. Thus, search of the next trial parameter can be performed on the basis of the control parameter for which the optimum value is obtained in the model evaluation value 6014 and the actual machine evaluation value 6015. In addition, for the trial parameter with which the model evaluation value 6014 lower than the actual machine evaluation value 6015 is obtained, the efficiency of the parallel search with the facility model 204 may be increased by performing pruning and/or by setting different search spaces.

According to the above-described embodiment of the present disclosure, in the case where a plurality of evaluation values of the facility model 204 of the automatic parameter adjustment system 100 is higher than the actual machine, the facility model 204 can be updated in the direction in which an output of the facility model 204 is closer to the actual machine output by adjusting a disturbance component of the facility model 204 and the like, and the trial parameter that possibly provides a high performance for the facility 103 can be selected from among the trial parameters of the facility model 204 and use it for the next trial parameter search. On the other hand, in the case where a plurality of evaluation values of the facility model 204 is lower than the actual machine, the facility model 204 can be updated in the direction in which the output of the facility model 204 comes closer to the actual machine output by adjusting the sensitivity of the facility model 204 and the like, and the trial parameter that is set to the facility 103 can be continuously used for the next trial parameter search. In the case where the model evaluation value and the actual machine evaluation value substantially match each other, the next trial parameter search can be performed on the basis of the control parameter for which the optimum value is obtained in the model evaluation value and the actual machine evaluation value. In addition, for the trial parameter with which a model evaluation value lower than the actual machine evaluation value is obtained, the efficiency of the parallel search of the facility model 204 can be improved by performing pruning and/or by setting different search spaces.

In this manner, search of a plurality of operation conditions can be efficiently performed by parallel search using the plurality of facility models 204. Modeling errors can be corrected while continuing the parameter search that is performed along with the actual machine operation that is time-consuming. The adjustment process can be presented to the user while reducing the adjustment time by narrowing down the search range on the basis of the result of the parameter search with the actual machine when the modeling error is reduced.

In the embodiment, the word “ . . . part” used for each component may be replaced by other words such as “ . . . circuit (circuitry)”, “ . . . assembly”, “ . . . device”, “ . . . unit”, and “ . . . module”.

The embodiments are described above with reference to the drawings, but the present disclosure is not limited to such examples. It is clear that one skilled in the art can conceive of various examples of changes or modifications within the scope of the claims. It is understood that such changes or modifications also belong to the technical scope of the present disclosure. In addition, each component in the embodiments may be arbitrarily combined to the extent that the intent of the present disclosure is not departed from.

The present disclosure may be realized in software, hardware, or software in conjunction with hardware. Each functional block used in the description of the above embodiments may be partially or entirely realized as an LSI, an integrated circuit, and each process described in the above embodiments may be partially or entirely controlled by a single LSI or a combination of LSIs. The LSI may be composed of individual chips or a single chip to include some or all of the functional blocks. The LSI may have data inputs and outputs. LSIs may be referred to as ICs, system LSIs, super LSIs, or ultra LSIs, depending on the level of integration.

The method of integrated circuitry is not limited to LSIs, but may be realized as dedicated circuits, general-purpose processors or dedicated processors. Field Programmable Gate Array (FPGA), which can be programmed after LSI manufacturing, and reconfigurable processors, which can reconfigure the connections and/or settings of circuit cells inside the LSI, may also be used. The present disclosure may be realized as digital or analog processing.

Furthermore, if another technology for integrated circuits that replaces LSI emerges due to advances in semiconductor technology or another derived technology, the integration of functional blocks may naturally be performed using that technology. The application of biotechnology, etc. may be a possibility.

Note that the following supplementary notes are further described below for the above descriptions.

### (Appendix 1)

An automatic parameter adjustment device comprising:
a plurality of facility models that model a facility:
a control parameter setter that sets a plurality of first control parameters for use in a first trial to the plurality of facility models, and set a second control parameter for use in the first trial to the facility; and
a comparer that compares a model operation result of the first trial of the plurality of facility models under the plurality of first control parameters with an actual machine operation result of the first trial of the facility under the second control parameter,
wherein the control parameter setter selects a control parameter for use in a second trial based on a first comparison result between the model operation result of the first trial and the actual machine operation result of the first trial.

### (Appendix 2)

The automatic parameter adjustment device according to appendix 1, further comprising a model updater that updates the plurality of facility models based on the first comparison result.

### (Appendix 3)

The automatic parameter adjustment device according to appendix 2,
wherein the comparer compares a plurality of model evaluation values representing the model operation result of the first trial with an actual machine evaluation value representing the actual machine operation result of the first trial, and
wherein when the plurality of model evaluation values are higher than the actual machine evaluation value by a predetermined first difference,
the model updater updates the plurality of facility models such that the plurality of model evaluation values are closer to the actual machine evaluation value, and
the control parameter setter selects the control parameter for use in the second trial based on the first control parameter corresponding to the model evaluation value closest to the actual machine evaluation value.

### (Appendix 4)

The automatic parameter adjustment device according to appendix 3,
wherein when the plurality of model evaluation values are lower than the actual machine evaluation value by a predetermined second difference,
the model updater updates the plurality of equipment models such that the plurality of model evaluation values are closer to the actual machine evaluation value, and
the control parameter setter selects the control parameter for use in the second trial based on the second control parameter.

### (Appendix 5)

The automatic parameter adjustment device according to appendix 4, wherein when the plurality of model evaluation values are not higher than the actual machine evaluation value by the predetermined first difference, and the plurality of model evaluation values is not lower than the actual machine evaluation value by the predetermined second difference, the control parameter setter selects the control parameter for use in the second trial based on the best one of the plurality of model evaluation values and the actual machine evaluation value.

### (Appendix 6)

An automatic parameter adjustment system comprising:
the automatic parameter adjustment device according to any one of appendices 1 to 5; and
a display device that displays the model operation result of the first trial and the actual machine operation result of the first trial.

### (Appendix 7)

A computer-implemented automatic parameter adjustment method, the method comprising:
setting a plurality of first control parameters for use in a first trial to a plurality of facility models modeling a facility, and setting a second control parameter for use in the first trial to the facility;
comparing a model operation result of the first trial of the plurality of facility models under the plurality of first control parameters with an actual machine operation result of the first trial of the facility under the second control parameter; and selecting a control parameter for use in a second trial based on a first comparison result between the model operation result of the first trial and the actual machine operation result of the first trial.

This application is entitled to and claims the benefit of Japanese Patent Application No. 2021-184816 filed on Nov. 12, 2021, the disclosure each of which including the specification, drawings and abstract is incorporated herein by reference in its entirety.

### INDUSTRIAL APPLICABILITY

An aspect of the present disclosure is suitable for automatic parameter adjustment systems.

### REFERENCE SIGNS LIST

100 Automatic parameter adjustment system
101 User interface (UI)
102 Parameter automatic adjuster
103 Facility
104 Sensor
201 Parallel searcher
202 Actual machine parameter searcher
203 Control parameter setter
204 Facility model
205 Comparer
206 Model updater

1. An automatic parameter adjustment device comprising:
a plurality of facility models that model a facility:
a control parameter setter that sets a plurality of first control parameters for use in a first trial to the plurality of facility models, and set a second control parameter for use in the first trial to the facility; and
a comparer that compares a model operation result of the first trial of the plurality of facility models under the plurality of first control parameters with an actual machine operation result of the first trial of the facility under the second control parameter,
wherein the control parameter setter selects a control parameter for use in a second trial based on a first comparison result between the model operation result of the first trial and the actual machine operation result of the first trial.

2. The automatic parameter adjustment device according to claim 1, further comprising a model updater that updates the plurality of facility models based on the first comparison result.

3. The automatic parameter adjustment device according to claim 2,
wherein the comparer compares a plurality of model evaluation values representing the model operation result of the first trial with an actual machine evaluation value representing the actual machine operation result of the first trial, and
wherein when the plurality of model evaluation values are higher than the actual machine evaluation value by a predetermined first difference,
the model updater updates the plurality of facility models such that the plurality of model evaluation values are closer to the actual machine evaluation value, and
the control parameter setter selects the control parameter for use in the second trial based on the first control parameter corresponding to the model evaluation value closest to the actual machine evaluation value.

4. The automatic parameter adjustment device according to claim 3,
wherein when the plurality of model evaluation values are lower than the actual machine evaluation value by a predetermined second difference,
the model updater updates the plurality of equipment models such that the plurality of model evaluation values are closer to the actual machine evaluation value, and
the control parameter setter selects the control parameter for use in the second trial based on the second control parameter.

5. The automatic parameter adjustment device according to claim 4, wherein when the plurality of model evaluation values are not higher than the actual machine evaluation value by the predetermined first difference, and the plurality of model evaluation values is not lower than the actual machine evaluation value by the predetermined second difference, the control parameter setter selects the control parameter for use in the second trial based on the best one of the plurality of model evaluation values and the actual machine evaluation value.

6. An automatic parameter adjustment system comprising:
the automatic parameter adjustment device according to claim 1; and
a display device that displays the model operation result of the first trial and the actual machine operation result of the first trial.

7. A computer-implemented automatic parameter adjustment method, the method comprising:
setting a plurality of first control parameters for use in a first trial to a plurality of facility models modeling a facility, and setting a second control parameter for use in the first trial to the facility;
comparing a model operation result of the first trial of the plurality of facility models under the plurality of first control parameters with an actual machine operation result of the first trial of the facility under the second control parameter; and
selecting a control parameter for use in a second trial based on a first comparison result between the model operation result of the first trial and the actual machine operation result of the first trial.
